(19) United States
(12) Patent Application Publication
(10) Pub. No.: US 2009/0187470 A1
(43) Pub. Date: Jul. 23, 2009

(54) METHOD FOR CARRYING OUT SURVEYS BY THE EXCHANGE OF TARGETED INFORMATION BETWEEN USERS AND WEB SITES OF A NETWORK

(75) Inventors: Frank SMADJA, Haifa (IL); Frederic Charles PETIT, Paris (FR)

Correspondence Address: BROWDY AND NEIMARK, P.L.L.C.;624 NINTH STREET, NW, SUITE 300, WASHINGTON, DC, 20001-5303, US

(73) Assignee: Toluna, Levallois-Perret (FR)

(21) Appl. No.: 12/257,192

(22) Filed: Oct. 23, 2008

(30) Foreign Application Priority Data
Jan. 23, 2008 (FR) 08 00353

(51) Int. Cl. G06Q 30/00

(52) U.S. Cl. 705/10

(57) ABSTRACT

The method according to the invention involves a plurality of Web sites each belonging to an editor and on which survey questionnaires may be displayed that are accessible to users distributed by means of a survey network, on the initiative of a plurality of advertisers who wish to carry out market surveys. It comprises the issuing by the advertiser of a survey questionnaire, the answer by the user to this questionnaire, a step where the advertiser asks the user additional questions, the qualification of the user based on the answers made to the additional questions and the provision to the user of a targeted content.

### BACKGROUND OF THE INVENTION

### Field of the Invention

This invention relates to a method for carrying out surveys by the exchange of information between users and network Web sites. It concerns the field of on-line targeted announcements and especially, but not exclusively, applies, to a particular type of announcements that can be used to carry out market surveys.

This type of announcement will be designated hereafter by the terms “survey questionnaires” or “surveys”. In its broadest sense and in the context of this application, a survey should be considered to be means which permit the opinions of a large number of on-line users to be collected. It may be presented in the form of a standard questionnaire wherein the users have to choose between several possible answers. However, it may also be designed so that it simply allows a user to give his/her opinion, knowledge, evaluation, etc. on any subject.

In its most general form, the survey questionnaire may consist of a announcement banner displayed on the screen and inviting the user to click on a sub-zone of the screen.

The owner of the Internet site on which the survey questionnaire is displayed is called “the editor”, the entity that wishes to carry out the market study is called “the advertiser” and the system which distributes the survey questionnaires to the editors is called the “survey enquiry network”.

The invention is based on the idea that to be of interest for the advertisers, the answers to the survey questions need to be qualified. In other terms, the advertisers need information on the users who have replied to a survey questionnaire. Usually, this additional information is classic demographic information. However, it may be more developed and include, for example, the family income, the number of children or persons cared for, their professional activity, etc.

Nevertheless, the problem that is raised results from the fact that the users are generally very reluctant to provide information of this type, especially when they visit the site of a third party (in this case, the editor's site).

Finally, the advertiser wishes to send what is called a targeted message to the user and this may only be carried out after the additional information has been provided by the user.

### OBJECT OF THE INVENTION

The purpose of the invention is therefore more particularly a method of carrying out surveys which allows the editor to be supplied with additional information concerning the user, without too many disadvantages for the latter.

### SUMMARY OF THE INVENTION

According to the invention, this method includes the following steps:

a first issuing step by the advertiser of a survey questionnaire,

a second step during which the user answers this questionnaire,

a third step where the advertiser asks the user a minimum number of additional questions, based on:

the type of qualification required by the advertiser

the information that the advertiser may already have on the user

a fourth step for the qualification of the user, based on the information collected during the third step,

a fifth step carried out after the user has been qualified, wherein this fifth step comprises the supply of a targeted content, in the form of an announcement or a targeted message that is much more relevant and effective than if it had been sent before collecting the information on the user.

### BRIEF DESCRIPTION OF THE DRAWINGS

One embodiment according to the invention is described below, by way of non-restrictive example, in reference to the appended drawings in which:

FIG. 1 is a block diagram of the architecture of a network for the implementation of the method according to the invention;

FIGS. 2, 3 and 4 are diagrammatical representations permitting the steps used by the method according to the invention to be illustrated.

### DESCRIPTION OF THE PREFERRED EMBODIMENTS

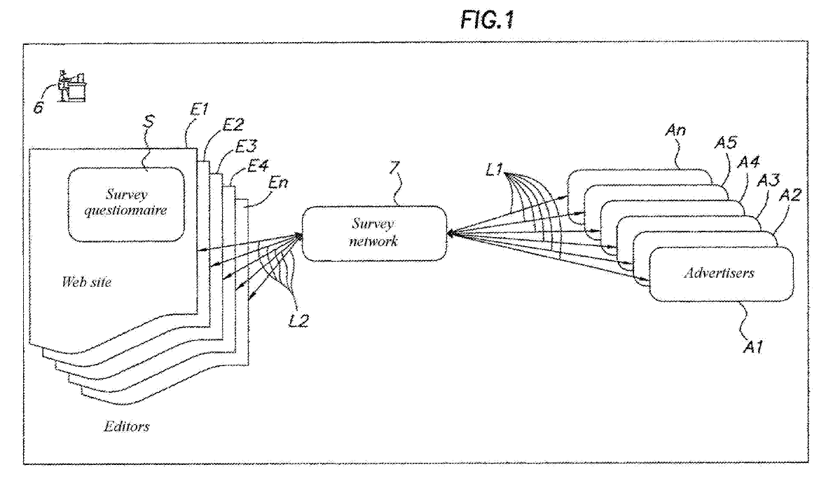

In the example shown in FIG. 1, the method according to the invention involves a plurality of Web sites E₁, E₂ . . . Eₙ each belonging to an editor. On each of these sites E₁, E₂ . . . Eₙ may be displayed a survey questionnaire S that is accessible by a user who has a computer system (processor/keyboard/screen) connected to the network. The survey questionnaires A₁, A₂ . . . Aₙ are distributed on the sites E₁, E₂ . . . Eₙ by means of a survey network 7, initiated by a plurality of advertisers who wish to carry out market surveys.

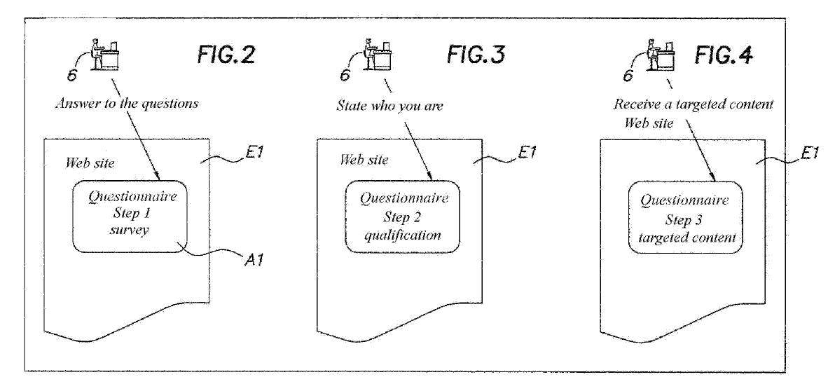

As illustrated in FIG. 2 which concerns the solicitation phase, initially the user 6 sees on a site E₁ a survey questionnaire A₁ which he considers relevant to the page of the editor hosting it.

Consequently, for example, if the editor is a blog site concerning cars, the survey questionnaire will be related to this subject and may ask the users to choose between several types of car. Given that the user is interested in cars, there is a strong probability that the survey questionnaire A₁ will attract the user 6 and incite the latter to click on the survey questionnaire S.

FIG. 2 shows a second phase, called the qualification phase, wherein once the user has replied to the survey questionnaire, the editor reuses the same zone or space of the screen occupied by the survey questionnaire to ask several additional questions. Usually, this space is very limited so that this may involve for example two or four simple questions. The user 6 has already taken an interest in the survey questionnaire and therefore will be more inclined to provide an additional item of information during this phase.

FIG. 3 illustrates a third phase, called the targeting phase, which is based on the hypothesis that at this point, the editor has the responses provided by the user 6 to the survey questionnaire A₁ as well as additional information. The editor may then display on his site E₁ a targeted message, or even an advert using this information.

By means of the measures described above, the method according to the invention may be implemented in the manner described below.

The clients interested by a market survey must pay to place the survey questionnaires and must specify the qualification of flow required to provide for example demographic requirements.

The clients that are interested by the targeted announcement must pay the network to place announcements and must specify user base targeted to specify for example demographic requirements.

The editors must provide the network which includes a space on the web site or on a Blog.

The survey network will then place the survey questionnaires on the sites of the editors, then the flow is qualified. The survey questionnaires may be replaced by announcements.

This process thus permits the following advantages to be obtained:

qualified responses may be obtained by the supply of additional information on the display zones of the survey questionnaires.

the provision of a CPM (cost per click, cost per thousand) that is high in comparison to other methods for qualifying flow.

the provision of a channel for content targeted to the users following qualification.

the provision to the user of a more varied content which consequently permits a higher CPM (cost per click, cost per thousand) to be obtained.

1. Method for carrying out surveys by multiple announcements on a network of affiliated Web sites, wherein this method involves a plurality of Web sites each belonging to an editor and on which survey questionnaires may be displayed that are accessible to users distributed by means of a survey network, on the initiative of a plurality of advertisers who wish to carry out market surveys, said method comprising the following steps:
a first issuing step by the advertiser of a survey questionnaire,
a second step during which the user answers this questionnaire,
a third step where the advertiser asks the user a minimum number of additional questions, based on:
the type of qualification required by the advertiser,
the information that the advertiser may already have on the user,
a fourth step for the qualification of the user, based on the information collected during the third step,
a fifth step carried out after the user has been qualified, wherein this fifth step comprises the supply of a targeted content, in the form of an announcement or a targeted message that is much more relevant and effective than if it had been sent before collecting the information on the user.

2. Method according to claim 1, wherein the survey form consists of an announcement zone that is displayed on the screen and which invites the user to click on, a sub-zone of the screen.

3. Method according to claim 2, reusing said announcement zone to ask said additional questions.

4. Method according to claim 1, wherein said announcement in said targeted message is based on the information received by the advertiser at the second and the fourth steps.
